(19) United States
(12) Patent Application Publication
(10) Pub. No.: US 2009/0241071 A1
(43) Pub. Date: Sep. 24, 2009

(54) Served ads as previews and summaries

(76) Inventors: Lisa Anne Seacat, San Francisco, CA (US); Travis M. Grigsby, Austin, TX (US); Christopher Scott Alkov, Austin, TX (US); Ruthie D. Lyle, Durham, NC (US)

Correspondence Address: MAXVALUEIP CONSULTING LLC, 11204 ALBERMYRTLE ROAD, POTOMAC, MD, 20854, US

(21) Appl. No.: 12/054,168

(22) Filed: Mar. 24, 2008

(51) Int. Cl. G06F 3/048

(52) U.S. Cl. 715/856

(57) ABSTRACT

When an appropriate context-sensitive ad is created for readers of a content page, it can also serve as a summary of page. In this context, the content indicates anything triggering a user's experience that may be used to decide what ad to show. This could be a particular web site, an application on user's computer, a virtual world, or even a physical location. An embodiment of this invention provides a method to serve the ads previously given on a page or other content to a user, at a time other than when the user is actually consuming that content. This Ads-as-a-summary concept can take various forms. It can also be leveraged at various times, such as a preview.

### BACKGROUND OF THE INVENTION

Contextual advertising is the term applied to advertisements appearing on websites or other media, such as content displayed in mobile phones, where the advertisements are selected and served by automated systems based on the content displayed by the user.

Contextual advertising, such as Google® AdSense®, has become a mainstay of advertising on the web. A tremendous amount of effort is put into showing ads (Advertisements) that are most appropriate to the readers of a particular page, users of a service or product, and the companies that do this type of advertising are generally keep the details of their algorithms proprietary. While these algorithms produce targeted and appropriate advertisements, the effort to find an appropriate ad is no longer leveraged after the ad (Advertisement) is served. There is an opportunity for this context extraction to not only provide an additional benefit to a user, but also serve more ads for a provider, and thus more brand recognition and traffic for an advertiser.

It has made a major impact on many websites. As the ads are more targeted, they are more likely to get clicked, thus, generating revenue for the owner of the website (and the server of the advertisement). Advertising on a web site is targeted to the specific individual who is visiting the Web site. A contextual ad system scans the text of a Web site for keywords and returns ads to the Web page, based on what the user is viewing. A contextual ad is the advertisement that dynamically appears on a Web site.

### SUMMARY OF THE INVENTION

When an appropriate context-sensitive ad is created for readers of a content page, it can also serve as a summary of page. In one embodiment, if all the ads are for sportswear on a site about “Puma”™, one does not have to click on the link to continue to that page when the user is actually looking for the “menacing stalker of the jungle”.

In this context, the content indicates anything triggering a user's experience that may be used to decide what ad to show. This could be a particular web site, an application on user's computer, a virtual world, or even a physical location.

An embodiment of this invention provides a method to serve the ads previously given on a page or other ‘content’ to a user, at a time other than when the user is actually consuming that content. This Ads-as-a-summary concept can take various forms. An embodiment of this invention can also be leveraged at various times, such as a preview, i.e. before a content page is entered, or afterwards, when the content is previously viewed, e.g., in order to reflect on events that have transpired.

### BRIEF DESCRIPTION OF THE DRAWINGS

FIG. 1 is a schematic diagram of the Ads as previews.

FIG. 2 is a data flow diagram showing Ads-as-a-summary.

### DETAILED DESCRIPTION OF THE PREFERRED EMBODIMENTS

In one embodiment of this invention, for the purpose of demonstration, but not limitation, the following steps are performed:
1. A contextual advertising company serves two ads for a particular page view of www.example.com.
2. That information is referenced in a search engine.
3. The next time a user enters a search query, www.example.com is returned.
When the user hovers the mouse over the link to go to the site, a tool tip appears with a list of those two ads in their normal compact form.
4. If the user clicks on the tool tip, the user is taken to the advertiser's site.
5. If the user clicks on site link in the search results, the user is taken to the site.

In one embodiment of this invention, Ads-as-a-summary gives the user a type of replay of what already occurred, e.g., if the user wants to be reminded of what happened in the past month, the user can choose to have the past thirty days ads for the user's on-line email account to be replayed to the user. Here, the email account (e.g., GMail®) is configured to be served ads based on the content of the email, and the replay of those ads would reflect the content of the user's previous emails.

An embodiment of this invention also uses other types of content, such as:
1. Chat rooms via text analysis
2. Virtual World conversations with voice and/or text analysis—in order to provide hints about which conversations are most appropriate to join
3. VOIP Services that do voice analysis—as a replay
4. Journaling/Email programs—as a replay
5. Video

A further embodiment of this invention provides the following: the ads served to a user are aggregated on that user's computer (instead of being centrally stored), and Ads-as-a-summary uses the locally stored served ads, if available and not expired.

In an embodiment of this invention, a summary content is also shown by:
a) displaying information about the tags that generated the ad (e.g., the “fire” tag triggered an ad for fire extinguishers).
b) displaying commonalities between ad triggers (e.g., all ads displayed contained the trigger “pets”) or other ad commonalities (e.g., all ads were for automobiles).
d) analyzing the differences in the ads/triggers to summarize content, e.g. drastically different ads may indicate multiple topics that can be called out in the summary.

In one embodiment of this invention, the ad server is configured to charge a different amount for click-through on ad summaries or an ad summary display fee, with respect to normal ads served on a content page.

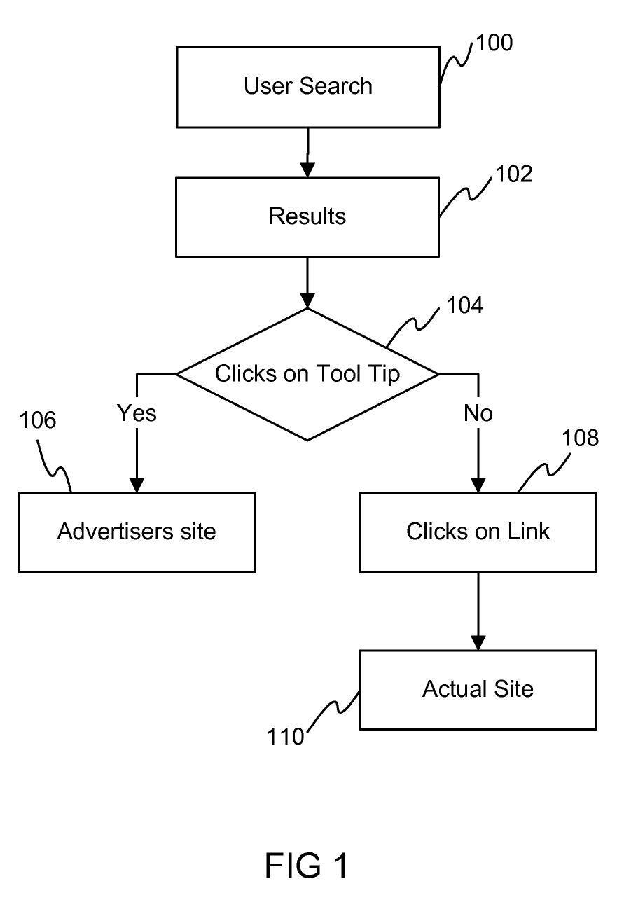

An embodiment of the invention is a method (FIG. 1) for the ads as previews. In one embodiment, a plurality of users may be connected via an external network, such as Internet, request search on a particular subject using a Search Engine (100). In one embodiment, a contextual advertising company serves two ads for a particular page view of www.example.com, and next time a user enters a search query, www.example.com is returned (102). When the user hovers the mouse over the link to go to the site, a tool tip appears with a list of those two ads in their normal compact form. In one embodiment, if the user clicks on the tool tip (104), the user is taken to the advertiser's site (106). In one embodiment, if the user clicks on site link in the search results (108), the user is taken to the site (110).

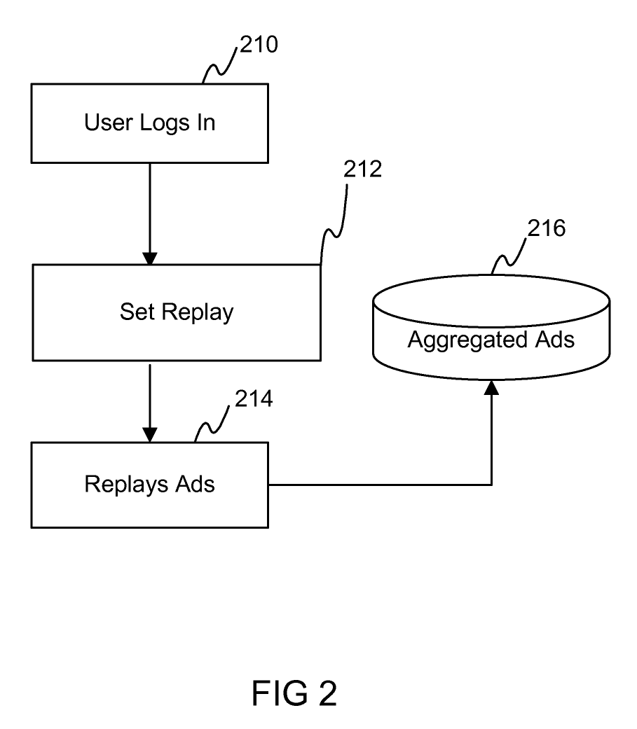

FIG. 2 is a schematic diagram illustrating an embodiment showing Ads-as-a-summary gives the user (210) a type of replay (212) of what already occurred, e.g., In one embodiment if the user (210) wants to be reminded of what happened in the past month, the user can choose to have the past thirty days ads for the user's on-line email account to be replayed (214) to the user. Here, the email account (e.g., GMail®) is configured to be served ads based on the content of the email, and the replay (212) of those ads would reflect the content of the user's previous emails. In an embodiment of this invention, the Ads-as-a-summary served to a user is aggregated on that user's computer (216).
One embodiment of the invention is a method for providing ad previews and summaries, the method comprising:
serving one or more contextual ads with a first content based on a first context of the first content;
providing a first web link to the first content as a query result from a search engine;
displaying a first graphical user interface associated with the first web link when a first user hovers a mouse over the first web link;
displaying the one or more contextual ads within the first graphical user interface ordered or grouped based on an ad generating tag associated with each ad of the one or more contextual ads or an ad trigger associated with each ad of the one or more contextual ads;
navigating to a first advertiser web site associated with a first ad of the one or more contextual ads, if the first user clicks on the first ad within the first graphical user interface;
for each second content belonging to a plurality of contents, replaying a second ad, if the second content satisfies a criteria; wherein the second ad was previously served with the second content based on a second context of the second content; wherein the plurality of contents have an attribute type and the second content has an attribute value of the attribute type; wherein a second user specifies a range of attributes; wherein the second content satisfies the criteria based on the attribute value and the range of attributes; and wherein in the replaying step, the second ad is replayed in an order based on the attribute value.

A system, apparatus, or device comprising one of the following items is an example of the invention: serving ads, preview, summary, computers, content, video, images, text, server, client device, PDA, mobile device, cell phone, storage to store the messages, router, switches, network, communication media, cables, fiber optics, physical layer, buffer, nodes, packet switches, computer monitor, or any display device, applying the method mentioned above, for purpose of advertising and ad management.

Any variations of the above teaching are also intended to be covered by this patent application.

1. A method for providing ad previews and summaries, said method comprising:
a user navigating to a web page by a web browser using on a web page uniform resource identifier associated with said web page;
generating first multiple contextual ads based on said first context of said first web content using tags and ad triggers associated with a first web content of said web page;
first serving said first multiple contextual ads to said user by displaying said web content with said first multiple contextual ads in said web browser;
after said first serving said first multiple contextual ads, accessing a search engine by said user, and searching and generating a query result using said search engine based on a query by said user, said query result comprising a web content link pointing to said web page via said web page uniform resource identifier;
displaying said search query result to said user in a first graphical user interface;
displaying a tooltip associated with said web content link, upon said user hovering a mouse over said web content link in said first graphical user interface;
replaying all said first multiple contextual ads in compact form within said tooltip by ordering and grouping said first multiple contextual ads based on said tags and ad triggers associated with said first web content;
navigating directly to a first advertiser web site associated with a first ad of first multiple contextual ads displayed in said tooltip, when said user clicks said mouse on said first ad within said tooltip, without navigating to said first web content;
accessing a web-based email client by said user;
for each email content of multiple emails for said user, performing steps comprising of:
providing one or more email contextual ads corresponding to said each email content, based on a second context of said each email content, and
second serving said one or more email contextual ads with said each email content to said user, by displaying said one or more email contextual ads with said each email content in said web-based email client;
wherein second multiple contextual ads comprise all of said one or more email contextual ads corresponding to all email contents of said multiple emails;
after all said second serving said one or more email contextual ads corresponding to all email contents of said multiple emails, specifying a range of attribute values for an attribute by said user via said web-based email client;
wherein said multiple emails have said attribute and said each email content has an attribute value for said attribute;
applying a criterion to said multiple emails, wherein said criterion is defined as whether said attribute value of said each email content is within said range of attribute values for said attribute; and
replaying all of said second multiple contextual ads corresponding to all of said multiple emails satisfying said criterion to said user in said web-based email client, ordered based on said attribute value.
